(19) United States
(12) Patent Application Publication
(10) Pub. No.: US 2022/0333728 A1
(43) Pub. Date: Oct. 20, 2022

(54) SYSTEM FOR LAUNCHING EQUIPMENT WITH A CABLE FOR INTERNALLY INSPECTING AND UNBLOCKING PRODUCTION, INJECTION AND DISTRIBUTION DUCTS

(71) Applicants: Petróleo Brasileiro S.A. - Petrobras, Rio de Janeiro (BR); Servico Nacional De Aprendizagem Industrial - Departamento Regional De Santa Catrina Sanai/SC, Florianopolis (BR)

(72) Inventors: Hugo Francisco Lisboa Santos, Rio de Janeiro (BR); Eduardo Gerhardt, Porto Alegre (BR); Andre Viegas Wentz, Porto Alegre (BR); Mauricio Galassi, Rio de Janeiro (BR); Cedric Hernalsteens, Niteroi (BR)

(21) Appl. No.: 17/620,580

(22) PCT Filed: Jun. 15, 2020
(86) PCT No.: PCT/BR2020/050212

§ 371 Date: Dec. 17, 2021

(30) Foreign Application Priority Data
Jun. 19, 2019 (BR) 10 2019 012854-2

(51) Int. Cl. F16L 55/46; E21B 33/06; E21B 37/00

(52) U.S. Cl. CPC F16L 55/46; E21B 33/061; E21B 37/00

(57) ABSTRACT

The present invention relates to a system for launching robots for use in oil and gas production wells, comprising a supporting structure (2), on which robot-launching tubing (4) is arranged; a dynamic seal (12) attached to the inlet end of the robot-launching tubing (4), which seals off the umbilical cable (8); an annular BOP valve (3) to restrict upward flow; and a ram BOP valve (7) at the other end of the tubing (4), to restrict upward flow and having a large enough opening to allow the robot to pass through, sealing off the umbilical cable (8). The system can be detached from the duct, used for transporting the robot, it can be flexible in terms of different configurations, and it can have a system that allows inertization of blocked lines. The present invention is used for introducing robots that operate internally in flexible and rigid ducts, with it being necessary to connect the tubing system to the equipment developed. Once connected, and by operating the valves of the system, it is possible to introduce the robot into the tubing.

### FIELD OF THE INVENTION

The present invention relates to a system for launching robots with a cable for use in oil and gas tubing. The system may be detached from the duct used to transport the robot, flexible to different configurations, and have a system that allows inertization in blocked lines. The present invention is used to introduce robots that operate internally in flexible and rigid ducts, with it being necessary connect the tubing system to the equipment developed. Once connected, and by operating the valves of the system, it is possible to introduce the robot into the tubing.

### DESCRIPTION OF THE STATE OF THE ART

The techniques currently used to unblock oil exploration tubing that has paraffin deposits or that is blocked due to the formation of some other type of solid hydrocarbon consists of heating the tubing or the region, using pig scrapers, or injecting crystal-modifying chemical products to dissolve the cause of the blockage. In addition to being extremely expensive operating activities, there is no guarantee that such methods will work and that oil flow will be established.

The use of semi-autonomous robots inside the blocked tubing is presented as a solution to this difficulty, which alternative encounters great resistance in the system to insert a robot inside ducts. The technique most similar to the present invention is the system to launch pigs from oil platforms, which is a system that requires a pressure differential between the entry and exit points for the pigs. However, the launch of semi-autonomous robots, which are connected to umbilical cables inside the tubing, is normally projected for “non-piggable” facilities, due to obstructions in the flow, because the obstruction prevents the pressure differential that is necessary for the pig-type equipment. Additionally, the launch of a robot, attached to an umbilical in a non-piggable tube through an already-existing pig-launching system, is not feasible due to the difficulty in distribution of the structures and equipment necessary on the topside of the platform. This is because of the need for major adaptations to the existing system and the incompatibility of the robotic equipment with the pig-launching system. Furthermore, a significant number of platforms do not have a pig launcher.

A robot for operation in deep water with the capacity to transport tools is inevitably long and heavy. For transport, it is necessary for it to already be in a section of the duct in which it may be activated and to initiate its descent through the flexible tube. As a safety requirement, electrical equipment needs to be protected to operate in a classified area. In the case of the interior of the duct there is an explosive atmosphere called Zone 0, which is the area with the highest risk of explosion. Therefore, in order for the robot to be energized, it is necessary for the interior of the launching duct to be filled with inert gas or fluid that expulses the oxygen outside the tube where the robot is located. Only in this way can it be guaranteed that no spark or hot surface on the robotic system will initiate an explosion.

If the robot has a connection to the surface, also known as an umbilical cable, the circumference of this cable needs to be sealed so that the entire interior of the launching duct is free of oxygen. However, after the robot begins its descent, that seal must be loosened so that the cable can enter the duct. When this umbilical enters the duct, there must be an outlet for the fluid or the internal pressure will increase inside the duct, creating more resistance to the movement of the robotic system or even preventing its movement.

If this robot is performing an unblocking operation, there is the risk that once the restriction is eliminated, the flow of pressurized oil or gas will rise through the duct up to the platform. This risk is critical for the safety of the platform, and safety must be ensured even if the umbilical cable is passing through the opening of the launching system. If the pressure coming from the well cannot be controlled, the robot cannot be removed from the duct, and more seriously, there is a risk of fire and explosion. There must therefore be a system that allows the robot to be removed with the pressurized duct. If the pressure is diverted by some drift in the duct that leads to the launcher, this drift must be such that it does not impede movement of the robot.

Platform safety cannot depend on just one component, therefore the safety systems must be redundant, and this redundancy cannot just be in duplicating systems, because the type of failure that affects an item can repeat. When the robot returns to the launching system, there must be a way for the umbilical cable volume that exits from the duct to be replaced with some fluid to prevent oxygen from entering into the tubing and creating an explosive atmosphere. Upon returning to the launching system, the components of the robot will be contaminated by oil, probably evaporating toxic gases, and there must be a way to wash the robot inside the launching system, because due to its size, washing in another location may not be feasible.

Document KR101384268B1 refers to a robot launcher and extractor, with this launcher being resident, and it is generally not applicable in situations in which it has not been installed previously. In the case of this invention, the launcher is detachable and can be installed on any FPSO (Floating Production Storage and Offloading) or semi-submersible platform, and removed after operation. The objective here is not to install a launcher on every FPSO.

In addition, document KR101384268B1 considers a robot without an umbilical. In the case of the present invention, a launching system for robots with an umbilical is proposed. Although this might seem like a small difference, the use of an umbilical allows a large volume of fluid to circulate.

Document ISBN 978-0-12-383846-9 (Standard Handbook of Petroleum and Natural Gas Engineering, by William C. Lyons) refers to a book with basic information on oil and gas production. Volumetric compensation, use of BOP, and use of inert fluids are typical operations in this technical field.

Document UPC 640522583300 refers to a wire stripper. Note that there is not a close relationship between the wire stripper presented in this document and the subject that is the purpose of the invention. In the case of the present invention, the intention is not to damage the cable. In the case of the wire stripper, the intention is to cut the cable's insulation. In the case of the present invention, stripping is a procedure that is done with the objective of allowing a cable to be inserted while maintaining the seal. In the case of the wire stripper, the stripping serves to cut the external layer of the insulation.

It is therefore noted that none of the documents mentioned above presents a strategy for insertion from the launcher into a blocked line. In these lines, the usual strategies of inertization are not applicable. Such strategies are, for example, diesel bullhead and nitrogen circulation.

Furthermore, none of these documents present a moveable trellised structure with flexible tubing. This allows use in different configurations, and its use in the riser balcony, for example. That structure presents good flexibility for adapting to different geometries.

In addition, none of these documents mentions or details the use of labyrinth-type seals for dynamic sealing of cables with axial translation.

As we will see later, with the system of the present invention, in addition to allowing access to the line, optionally the equipment may also serve to transport the robot.

None of the documents mentioned above indicate how to allow the entry of the umbilical while maintaining the system's sealing intact.

Documents US20080202594A1, U.S. Pat. No. 6,769,152B1 and U.S. Pat. No. 5,219,244A illustrate pig-launching systems, and it is noted that despite being in relation to an inlet point for a robot, this is not adequate if it has an umbilical cable, in addition to not allowing the robot-moving system to act if it cannot adapt to the variations in the diameter of the line.

Document US201 6369931A describes a launching system for a pressurized tube that includes a structure that can be attached to the tubing such that the interior of the structure is open to an interior of the tubing and an exterior of the structure is exposed to an external environment to the tubing. A first actuator array is placed on the outside of the structure, and a second actuator array is placed inside the structure. A sealing array is placed in the casing between the first actuator array and the second actuator array. Each of the arrays from the first and second actuators are configured to receive a cable with a part that extends outside the structure, a part that extends through the sealing array, and a part that extends inside the casing. The actuator arrays can be operated independently to pull the cable in relation to the sealing array to move the cable inside and outside the piping.

The structure presented in US201 6369931A includes a sealing array that is configured to wrap a cable that extends outside of the piping to inside the piping, such that the release of pressurized gas from within the piping to an external environment to the piping is prevented.

In addition, US201 6369931A describes a blowout prevention array in a launcher, considering the existence of supply cables with annular-type seals. It should be noted that the present invention uses a labyrinth-type sealing system.

Note that a platform to launch robots for cleaning and/or inspecting ducts in deep water capable of transporting tools, is long and heavy. To start the journey, it is necessary for the robot to already be in a section of tube to facilitate transport, and considering the high risk of explosion, its electrical system must be initiated safely. It must be capable of descending and ascending through the flexible duct. Since the use of a control and energy umbilical cord is common, the system that prevents fluid from rising, the blowout system, must consider the existence of the cord. The drift, which diverts pressure from the duct, must exist in such a way that it does not hinder the robot's movement, and it is necessary to create redundancies for greater safety. It is necessary for there to be volumetric compensation and pressure in the duct to offset the entry and exit of the robot and cable, both to prevent a blowout, and to prevent oxygen from entering the duct. There is also a need for a cleaning system to remove hydrocarbons and vapors from the robot.

To resolve these problems, the present invention presents a launching and retrieval system for cleaning or inspecting robots. It is an inclined tube to facilitate launch of the robot. The tube is fitted into an exploration or drilling duct. It has valves to prevent blowouts, which takes into consideration the existence of an umbilical cable. The invention incorporates a system for cleaning the robot inside the launching tube, use of inert fluid to safely initiate the robot's electrical system, and a system that compensates for a change in volume and pressure inside the duct by inserting or removing the robot and its cable. The invention also modifies the region of drift by degrees to facilitate attaching the robots with hooks and/or clamps in order not to prevent the drift of the duct.

### BRIEF DESCRIPTION OF THE DRAWINGS

The present invention will be described in greater detail below, referencing the attached drawings which, in a manner not limiting to the scope of the invention, show a preferential embodiment of execution. Therefore:

FIG. 1 shows the system of the present invention being installed in a storage and control module;

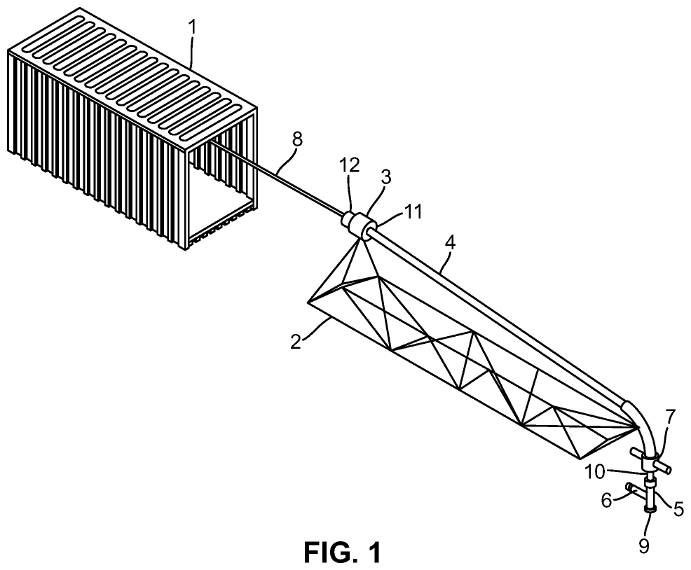

FIG. 2 shows a view referring to the use of labyrinth-type seals for dynamic blocking of cables with axial translation of the present invention.

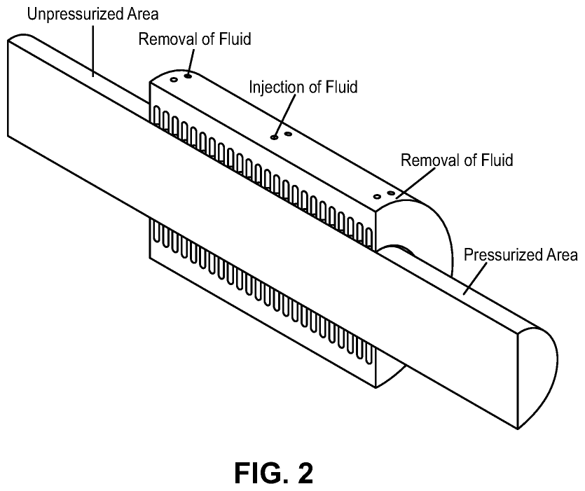

### DETAILED DESCRIPTION OF THE INVENTION

The system of this invention comprises a support structure (2) where the robot-launching tube is placed (4); on the inlet end of that tube a dynamic seal is attached (12), sealing over the umbilical cable (8), and an annular BOP (Blowout Preventer) valve (3) responsible for restricting the ascending flow. The dynamic seal (12) and the valve (3) will be detached, either by disassembly or by opening to introduce the robot or connection of the umbilical to the robot. There is a ram BOP valve (7) on the other end of the tube (4), which restricts ascending flows. The ram BOP valve (7) must have an opening that is large enough to allow passage of the robot, and it must be capable of sealing over the umbilical cable (8).

After the BOP valves (3) and (7), there are two valves (10) and (11). They are used in the process of inertization and cleaning of the equipment, with valve (11) being the inlet and valve (10) being the outlet for the cleaning or inertization fluid, or vice versa.

After valve (10), on the final end of the launching tube (4), there will be a ball valve (5) for access to the piping, and right after that there will be a branch (9) with a valve (6) to direct the excess fluid directly to the burner. This drift will have a framework in the branch hole from the principal tube so that there is support for the robot on that framework, to allow movement of the robot.

The equipment is connected to the production duct into which the robot will be introduced by the branch (9). Before the support structure (2) a storage module will be installed (1) from the umbilical cable and the robot control center and from the process. The dynamic seal (12) in particular may assume different configurations. One optional configuration is the use of metal, ceramic or elastomer seals, in this case with or without internal steel frameworks. These seals may be of different types and materials: o-ring, x-ring, v-ring, u-cup, square, rectangular, lips, etc. Another optional configuration is the use of labyrinth-type seals and multi-stage labyrinth-type seals. Optionally, this labyrinth-type seal may have internal inflows and/or outflows of fluid to prevent the fluid from the line escaping into the environment. The labyrinth-type seal may assume different geometries, such as a straight seal, a rectangular seal, and a toothed seal. It may also, optionally, present scrapers to increase the loss of load.

The present invention therefore includes a tube that is inclined (4) in relation to the horizontal where the robotic system is enclosed for transport and connection to a hydrocarbon production line. This tube allows movement of the robot through its locomotion system and resists the pressure that might come from the well.

The present invention incorporates two valves (10, 11) into the tube (4) on each end of the tube (4) so that the tube is purged of any oxygen and filled with inert fluid.

At the tube entry (4) an annular BOP valve (3) is used to regulate the pressure from closing its elastomer interface over the circumference of the robot's umbilical cable. This may be completely opened to allow access to the robot at the time of its assembly, where it is connected to an umbilical cable, or closed over the cable when a pressure peak reaches the system.

Additionally, a valve (11) is used in the invention to collect fluid from the inside of the duct as the umbilical cable enters into it, performing volumetric compensation.

If, during the intervention, the line is exposed to pressure from the well, the invention has a drift (9) so that the fluid pressure can drain to the burner on the platform, or to a storage tank. Inevitably there will be pressure in the launching tube (4), and if the dynamic seal is not capable of maintaining the pressure, the annular BOP valve (3) will be activated, preventing leaks in the region of the launcher. Optionally, as a redundancy for the safety of the system, a second BOP valve, although ram type (7), may be positioned immediately above the drift (9), sealing around the umbilical cable if there are any issues with the dynamic seal and the annular BOP valve (3).

The present invention uses a dynamic seal (12) to allow passage of the cable while maintaining the seal. Alternatively, the annular BOP valve (3) may be used to perform the procedure known as stripping, where the umbilical cable is pulled with the pressurized annular valve over the circumference of the cable to prevent this interface from leaking fluid from the well. After the robot returns to the launching tube (4) a conventional valve (5) is activated and it isolates the launching tube (4) for safe removal of the robot.

Furthermore, the present invention modifies the area of the drift, where the orifice that leads to the tube section that is connected in the valve (6) has a framework so that the feet of the robot are supported, but without blocking the flow of hydrocarbons coming from the well. For this reason, different types of BOP valves are used, an annular and a ram valve, in order to ensure that the same type of failure does not occur in both valves.

Fluid is inserted through the valve (11) into the launching tube as the robot returns and the umbilical cable is retracted.

Using the valves (10) and (11), after the valve is closed (5), the solvent may be circulated through the launching tube (4) until the components of the robot are free of oil.

It should be noted that despite the present invention having been described in relation to the attached drawings, it may undergo modifications and adaptations by technicians versed in the matter, depending on the specific situation, but as long as it remains within the scope of the invention defined herein.

1.-12. (canceled)

13. A system for launching equipment, comprising:
a support structure comprising a robot-launching tube;
a sealing array comprising at least one of:
a dynamic seal attached on the inlet end of the robot-launching tube and sealed over an umbilical cable;
an annular BOP valve to restrict ascending flow; and
a ram-type BOP valve on the other end of the tubing to restrict the ascending flow and to have an opening that is sufficient to allow passage of a robot, wherein the ram-type BOP valve is sealed over the umbilical cable.

14. The system of claim 13, wherein the dynamic seal and the annular BOP valve are detachable.

15. The system of claim 14, wherein the dynamic seal and the annular BOP valve are detachable by disassembly.

16. The system of claim 14, wherein the dynamic seal and the annular BOP valve are detachable by opening to introduce the robot or connection of the umbilical to the robot.

17. The system of claim 13, further comprises a first valve and a second valve on each end of the robot-launching tube so that the robot-launching tube is purged of any oxygen and filled with inert fluid, wherein the second valve is configured for entry and the first valve is configured for outflow of the cleaning or inertization fluid.

18. The system of claim 17, wherein the inert fluid is inserted into the robot-launching tube through the second valve as the robot returns and the umbilical cable is retracted.

19. The system of claim 13, wherein a valve is activated after the robot returns to the robot-launching tube and to isolate that robot-launching tube for safe removal of the robot.

20. The system of claim 19, wherein solvent is circulated through the robot-launching tube after the valve is closed and until the components of the robot are free of oil.

21. The system of claim 13, further comprising a branch with a valve for sending excess fluid directly to a burner.

22. The system of claim 21, wherein the branch is a sloped branch so that there is support for the robot to allow the robot to move.

23. The system of claim 13, wherein the dynamic seal has a configuration for use of metal, ceramic or elastomer seals, with or without internal steel structures.

24. The system of claim 23, wherein the metal, ceramic, or elastomer seals are selected from the group consisting of o-ring, v-rings, u-cups, squared, rectangles, and lips.

25. The system of claim 23, wherein the seals used are labyrinth-type seals and multi-stage labyrinth-type seals.

26. The system of claim 25, wherein the geometry of the labyrinth-type seal is selected from the group consisting of a straight seal, a rectangular seal, and a toothed seal.
